(19) United States
(12) Patent Application Publication
(10) Pub. No.: US 2006/0115277 A1
(43) Pub. Date: Jun. 1, 2006

(54) Optical communication system

(75) Inventors: Hidenori Yamada, Ashigarakami-gun (JP); Takehiro Niitsu, Ashigarakami-gun (JP); Shinya Kyozuka, Ashigarakami-gun (JP); Kazuhiro Suzuki, Ashigarakami-gun (JP); Tomo Baba, Ashigarakami-gun (JP); Shinobu Ozeki, Minamiashigara-shi (JP); Kouichiro Yoshimura, Meguro-ku (JP); Atsunobu Sugimoto, Meguro-ku (JP)

Correspondence Address: OLIFF & BERRIDGE, PLC, P.O. BOX 19928, ALEXANDRIA, VA, 22320, US

(73) Assignees: FUJI XEROX CO., LTD., Tokyo (JP); HONDA TSUSHIN KOGYO CO., LTD., Tokyo (JP)

(21) Appl. No.: 11/138,350

(22) Filed: May 27, 2005

(30) Foreign Application Priority Data
Dec. 1, 2004 (JP) 2004-348853

(51) Int. Cl. H04B 10/12

(52) U.S. Cl. 398/143

(57) ABSTRACT

The present invention provides a method for reducing propagation errors in an optical communication system which includes an optical element and an optical transmission medium. In the present invention, a relative position of the optical element and an end face of the optical transmission medium, at which light emitted from the optical element is incident, is set to a (relative) position which is different from a relative position of the optical element and the end face of the optical transmission medium with which energy of light that is propagated is maximized. Then, light emitted from the optical element is propagated in multimode by the optical transmission medium.

### CROSS-REFERENCE TO RELATED APPLICATION

This application claims priority under 35 USC 119 from Japanese Patent Application No. 2004-348853, the disclosure of which is incorporated by reference herein.

### BACKGROUND OF THE INVENTION

1. Field of the Invention

The present invention relates to an optical communication system. More particularly, the present invention relates to an optical communication system, a method for reducing errors in an optical communication system, a butt-optical-coupling structure for an optical element and an optical transmission medium, and an optical coupling structure for an optical element and an optical transmission medium.

2. Description of the Related Art

In recent years, optical linking systems have been employed in the field of optical communications, in which digital apparatuses such as electronic equipment and the like are connected with one another and long-distance propagation of high-speed signals that is not possible with electronic transmissions is performed. An optical linking system has a structure in which electronic signals are converted to optical signals, light of the optical signals is irradiated from a transmitter into a light-guiding medium (an optical fiber or the like) by a transmission side optical coupling component, the optical signals are propagated through the light-guiding medium, the light is irradiated from the light-guiding medium to a receiver by a reception side optical coupling component, and the optical signals are converted to electronic signals at the receiver.

In the field of optical communications relating to such optical linking systems, multimode optical fibers such as plastic optical fibers and the like have been employed, and application thereof to digital optical communications over comparatively long distances has been implemented, for propagating signals of the order of hundreds of megabits per second over distances of the order of tens of meters.

Conventionally, when digital apparatuses are to be connected to one another and digital optical communications performed, as shown in FIG. 17, it is usual for respective digital apparatuses 10 and 11 to be detachably connected to corresponding end portions of an optical fiber cable 12 with respective connectors 14 and 16.

As shown in the example in FIG. 18, the connector 14 or 16 has a structure in which an optical fiber connection device 18 is detachably connected, optically and mechanically, to an object component 20. This optical fiber connection device 18 is a male connector of the optical fiber cable 12, whereas the object component 20 is a female connector provided at the digital apparatus 10 or 11. The optical fiber connection device 18 is provided with a main body 22 and an insertion terminal 24. The main body 22 functions as a grip portion which can be held by a hand of an operator for inserting the insertion terminal 24 into an insertion hole 26 of the object component 20 and removing the insertion terminal 24 from the insertion hole 26.

At an end face of the insertion terminal 24, a corresponding end portion of the optical fiber cable 12 is exposed. The insertion terminal 24 is, for example, a cylindrical or square rod-form member. A catch portion is provided partway along the insertion terminal 24. This catch portion fits into a recess portion formed partway along the insertion hole 26 of the object component 20. Hence, a state in which the optical fiber connection device 18 and the object component 20 are optically and mechanically connected is maintained.

A lens 28 and a light-sensitive element 30 (or a light emitting element 32) are provided at an interior bottom portion of the insertion hole 26 of the object component 20.

This optical fiber connection device 18 is structured such that, in the state in which the insertion terminal 24 is fitted into the insertion hole 26 of the object component 20, an end portion of the optical fiber cable 12 faces the lens 28 and light-sensitive element 30 (or light emitting element 32).

In a case in which the light-sensitive element 30 is disposed in the object component 20 of the first connector 14, an optical signal is guided thereto along the optical fiber cable 12, and the light is received at the light-sensitive element 30 via the lens 28. Further, in a case in which the light emitting element 32 is disposed at the object component 20 of the second connector 16, an optical signal that the light emitting element 32 generates passes through the lens 28 and is incident at the end portion of the optical fiber cable 12.

The first connector 14 is structured such that, when a light beam that is emitted from the end portion of the optical fiber cable 12 passes through the lens 28 and is received at the light-sensitive element 30, light energy thereof is at a maximum value. Meanwhile, the other connector 16 is structured such that, when an optical signal that is emitted by the light emitting element 32 passes through the lens 28 and is incident at the end portion of the optical fiber cable 12, light energy thereof is at a maximum value.

Thus, the digital apparatuses 10 and 11 and the corresponding end portions of the optical fiber cable 12 are optically and mechanically connected such that energy coupling efficiencies between the respective optical fiber connection devices 18 and object components 20 are maximized. An optical linking component has been proposed which implements digital optical communications between digital apparatuses by, in a thus optimized state, propagating optical signals which have been emitted from the light emitting element 32 of one of the apparatuses through the optical fiber cable 12 to the other apparatus, and detecting the optical signals with the light-sensitive element 30 of the other apparatus (see, for example, Japanese Patent Application Laid-Open (JP-A) No. 2000-137150).

When the optical fiber connection device 18 and object component 20 structured as described above are employed in an optical linking system, a main point is to couple between an optical element and a light propagation medium with an optical coupling structure (which is for irradiating light from a transmitter that converts electronic signals to optical signals into a light-guiding medium (an optical fiber or the like) with a transmission side optical coupling component) such that light energy from the transmitter into the light-guiding medium is at a maximum possible limit amount. Further, in an optical linking system which is structured in such a manner, a main point is to couple between a light propagation medium and an optical element with an optical coupling structure (which is provided between the light-guiding medium and a receiver for irradiating the optical signals that have been propagated through the light-guiding medium into the receiver and converting the optical signals to electronic signals) such that light energy from the light propagation medium into the receiver is at a maximum possible limit amount. Thus, with optical coupling structures for which coupling of optical elements with light propagation mediums such that light energies are at maximum possible limit amounts is a principal focus as described above, it is not possible to prevent propagation errors from occurring in high-speed transmissions.

### SUMMARY OF THE INVENTION

The present invention has been made in view of the above circumstances and provides an optical communication system, a method for reducing communication errors in an optical communication system, a butt-optical-coupling structure, and an optical coupling structure.

A first aspect of the present invention is a method for reducing communication errors in an optical communication system which includes an optical element and an optical transmission medium, the method including: setting a relative position of the optical element and an end face of the optical transmission medium, at which light emitted from the optical element is incident, to a (relative) position which is different from a relative position of the optical element and the end face of the optical transmission medium with which propagated light energy is maximized; and propagating, in multimode, light emitted from the optical element through the optical transmission medium.

A butt-optical-coupling structure of a second aspect of the present invention includes: an optical element; and an optical transmission medium which propagates, in multimode, light emitted from the optical element, wherein a relative position of the optical element and an end face of the optical transmission medium is set to a (relative) position which differs, by a predetermined distance in a direction of an optical axis of the optical transmission medium, from a relative position of the optical element and the end face of the optical transmission medium with which propagated light energy is maximized.

An optical coupling structure of a third aspect of the present invention includes: an optical element; at least one collector lens; and an optical transmission medium which transmits/receives light emitted from the optical element via the collector lens and propagates the light in multimode, wherein a relative position of the optical element and an end face of the optical transmission medium is set to a (relative) position which differs, by a predetermined distance in a direction of an optical axis of the optical transmission medium, from a relative position of the optical element and the end face of the optical transmission medium with which propagated light energy is maximized.

An optical communication system of a fourth aspect of the present invention includes: a first signal communication apparatus; a second signal communication apparatus; and an optical signal propagation medium which propagates light between the first signal communication apparatus and the second signal communication apparatus in multimode. The first signal communication apparatus is provided with a first optical element and the second signal communication apparatus is provided with a second optical element. The first signal communication apparatus converts at least some of electronic signals inputted from outside the optical communication system to optical signals with the first optical element, and transmits the optical signals into the optical signal propagation medium. The second signal communication apparatus receives the optical signals from the optical signal propagation medium, converts at least some of the optical signals to electronic signals with the second optical element, and outputs the electronic signals to outside the optical communication system. A relative position of the first optical element and a first optical element side end face of the optical transmission medium is set to a (relative) position which differs, by a predetermined distance in a direction of an optical axis of the optical transmission medium, from a relative position of the first optical element and the end face of the optical transmission medium with which propagated light energy is maximized.

According to the present invention as described above, it is possible to reduce communication errors in high-speed transmissions of optical signals.

### BRIEF DESCRIPTION OF THE DRAWINGS

Preferred embodiments of the present invention will be described in detail based on the following figures, wherein:

FIG. 1 shows a portion of an optical linking system which includes optical coupling structures, between optical elements and a light propagation medium, of the present invention;

FIG. 2 shows an optical coupling structure, between an optical element and a light propagation medium, relating to a first embodiment of the present invention;

FIG. 3 shows the optical coupling structure, between the optical element and the light propagation medium, relating to the first embodiment of the present invention;

FIG. 4 shows another optical coupling structure, between an optical element and a light propagation medium, relating to the first embodiment of the present invention;

FIG. 5 shows yet another optical coupling structure, between an optical element and a light propagation medium, relating to the first embodiment of the present invention;

FIG. 6 shows an optical coupling structure, between an optical element and a light propagation medium, of a related art;

FIG. 7 shows an optical coupling structure, between an optical element and a light propagation medium, relating to a second embodiment of the present invention;

FIG. 8 shows the optical coupling structure, between the optical element and the light propagation medium, relating to the second embodiment of the present invention;

FIG. 9 shows another optical coupling structure, between an optical element and a light propagation medium, relating to the second embodiment of the present invention;

FIG. 10 shows yet another optical coupling structure, between an optical element and a light propagation medium, relating to the second embodiment of the present invention;

FIG. 11 shows an optical coupling structure, between an optical element and a light propagation medium, of a related art;

FIG. 12 shows relationships between propagation errors and separation of an optical element from an end face of a light propagation medium;

FIG. 13 shows relationships between propagation errors and separation of an optical element from an end face of a light propagation medium;

FIG. 14 shows structure of an optical fiber;

FIG. 15 shows a separation between an optical element and an end face of a light propagation medium;

FIG. 16 shows a separation between an optical element and an end face of a light propagation medium;

FIG. 17 shows an optical communication system of a related art, in which digital apparatuses are connected to one another and digital optical communication is performed; and

FIG. 18 shows an optically and mechanically attachable and detachable optical fiber connection device of the related art.

### DETAILED DESCRIPTION OF THE INVENTION

First Embodiment

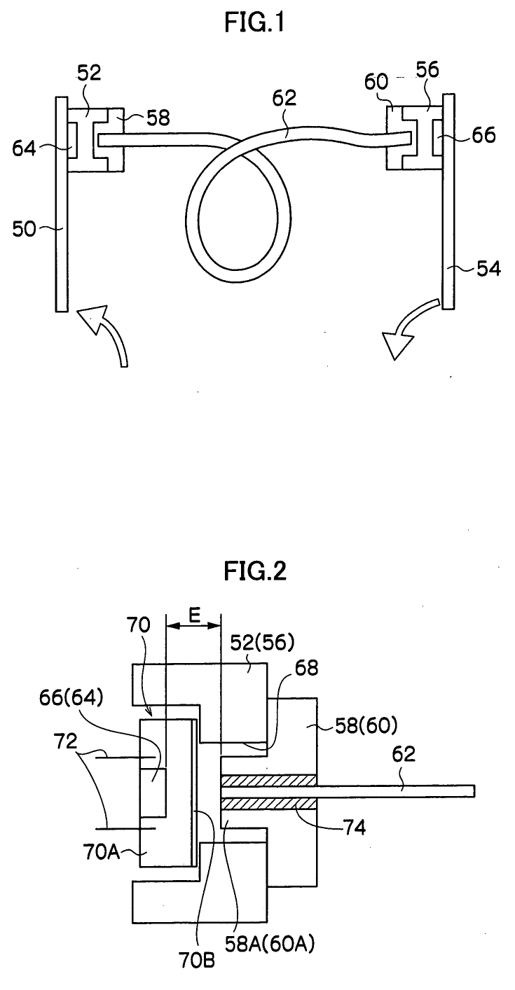

A first embodiment of the present invention, which relates to an optical coupling structure between an optical element and an optical transmission medium of the present invention and to an optical linking system (corresponding to an optical communication system) which employs this optical coupling structure, will be described in accordance with FIGS. 1 to 6 and FIGS. 12 to 16.

As shown in FIG. 1, an optical linking system relating to this first embodiment is provided with a transmitter 50 (corresponding to a first signal communication apparatus), a receptacle 52, a receiver 54 (corresponding to a second signal communication apparatus), a receptacle 56, and an optical fiber cable (a multimode optical fiber) 62 (corresponding to an optical transmission medium/an optical signal propagation medium). The transmitter 50 is equipped with a circuit which converts inputted electronic signals to optical signals. The receptacle 52 is disposed at the transmitter 50. The receiver 54 is equipped with a circuit which converts optical signals to electronic signals and outputs the electronic signals. The receptacle 56 is disposed at the receiver 54. The optical fiber cable 62 (which could be an optical waveguide plate or the like) serves as a propagation medium. An input plug 58, which is an optical coupling component for optically and mechanically coupling the optical fiber cable 62 with the receptacle 52 of the transmitter 50, is provided at one end portion of the optical fiber cable 62. An output plug 60, which is an optical coupling component for optically and mechanically coupling the optical fiber cable 62 with the receptacle 56 of the receiver 54, is provided at another end portion of the optical fiber cable 62.

In this optical linking system, a light emitting element 64 (corresponding to a first optical element), which is an optical device, is disposed inside the receptacle 52, and a light-sensitive element 66 (corresponding to a second optical element), which is an optical device, is disposed inside the receptacle 56.

This optical linking system is structured as a multimode light beam propagation system. The optical linking system is structured with the receptacle 52 and the input plug 58 and with the receptacle 56 and the output plug 60 such that propagation errors during propagation of optical signals by multimode light beams are lowered and such that propagated light energy is appropriately maintained.

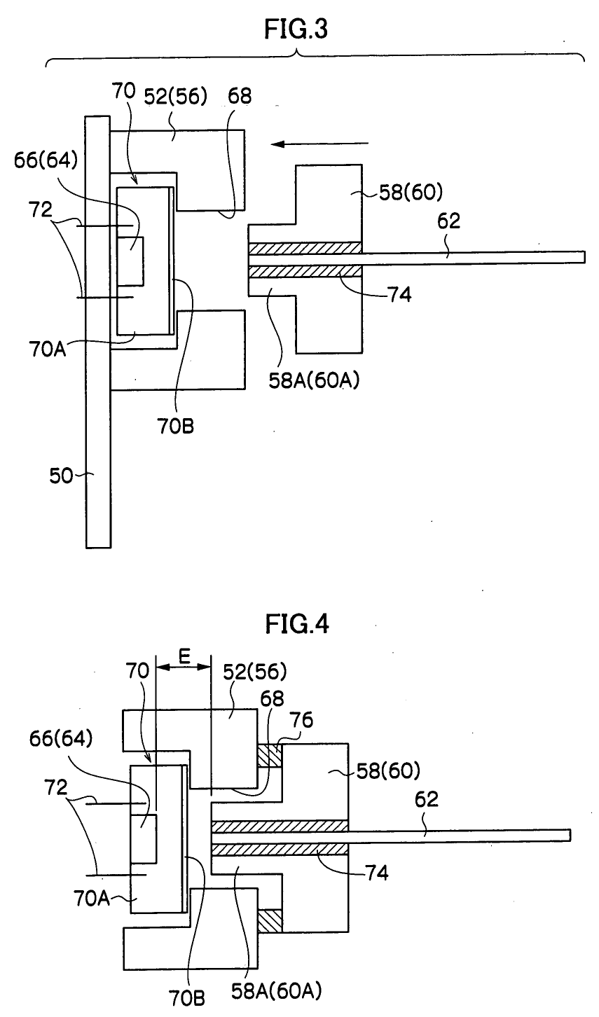

As shown by the example in FIGS. 2 and 3, the optical linking system has a structure in which the receptacle 52 and the input plug 58 are buttingly coupled.

At the receptacle 52, a coupling insertion hole 68 is formed in a housing of the receptacle 52, and an optical element package 70 is disposed directly behind the coupling insertion hole 68. The optical element package 70 provided at the receptacle 52 of the transmitter 50 has a structure in which the light emitting element 64 is disposed on an interior bottom face of a package 70A fabricated of ceramic or the like (the package 70A could be a metal package, a resin package or the like), and a window portion 70B is provided to allow emission of a multimode light beam, which is emitted from the light emitting element 64, through the window portion 70B and to the exterior. The optical element package 70 is structured to be connected with a circuit of the transmitter 50 by electronic terminals 72 which are protruded from a bottom face of the package 70A.

The receptacle 56 at the receiver 54 side has a similar structure to the receptacle 52 at the transmitter 50 side, except that the light-sensitive element 66 is provided instead of the light emitting element 64.

At the input plug 58, which is for connecting at the receptacle 52, a ferrule 74 is integrally provided at the middle of an insertion portion 58A, which is for insertion into the coupling insertion hole 68. An end portion of the optical fiber cable 62, which is a multimode optical fiber, is assembled to this ferrule 74 so as to run along a central axis of the coupling insertion hole 68. At the output plug 60, similarly to the input plug 58, another ferrule 74 is integrally provided at the middle of an insertion portion 60A, which is for insertion into the coupling insertion hole 68. An end portion of the optical fiber cable 62 is attached to this ferrule 74, so as to run along a central axis of the coupling insertion hole 68.

In a butting-coupling optical coupling component structured by the receptacle 52 and the input plug 58, in order to reduce propagation errors, relative positions of a front face (a light emission face) of the light emitting element 64 which is an optical device and an end face of the optical fiber cable 62 are specified such that, in the state in which the input plug 58 is connected to the receptacle 52, a distance from the light emission face to the end face of the optical fiber cable 62 is in a range specified for reducing propagation errors E. Similarly, relative positions of a front face (a light-receiving face) of the light-sensitive element 66 which is an optical device and another end face of the optical fiber cable 62 are specified such that, in the state in which the output plug 60 is connected to the receptacle 56, a distance from the light-receiving face to the end face of the optical fiber cable 62 is in the propagation error reduction setting range E. More specifically, for example, the insertion portion 58A of the input plug 58 is formed to be shortened by a predetermined length and the insertion portion 60A of the output plug 60 is formed to be shortened by a predetermined length.

In practical terms, the propagation error reduction setting range E of this butting coupling is specified as a separation from a front face of the window portion 70B to the end face of the optical fiber cable 62. Because the optical element package 70 has a structure in which a range from the front face of the light emitting element 64 (or the light-sensitive element 66) to the front face of the window portion 70B is closed off, it is not possible to include a distance from the front face of the light emitting element 64 (or the light-sensitive element 66) to the front face of the window portion 70B in the propagation error reduction setting range.

In a butting coupling that is structured thus, the end portion of the optical fiber cable 62 is closest to the light emitting element 64 (or the light-sensitive element 66) when the end portion of the optical fiber cable 62 is closely contacted with the front face of the window portion 70B. Note that in conventional butting coupling, as in the comparative example shown in FIG. 6, it is usual for the end face of the optical fiber cable 62 to be disposed adjacent to the window portion 70B of the optical element package 70 such that coupling efficiency of energy from the light emitting element 64 (or the light-sensitive element 66) into the optical coupling component is maximized.

A relationship between the distance from the front face of the window portion 70B to the end portion of the optical fiber cable 62 and an amount of propagation errors is found by experiment and evaluated, and the propagation error reduction setting range E of this butting coupling is set to a suitable range which is capable of reducing propagation errors.

An experiment to establish this propagation error reduction setting range E was conducted on an optical coupling component buttingly coupling the receptacle 56 to the output plug 60. This test to establish the propagation error reduction setting range E was performed by separating the end portion of the optical fiber cable 62 in a number of separation steps from a position of close contact between the end portion of the optical fiber cable 62 and the front face of the window portion 70B (i.e., from a separation at which the coupling efficiency of energy from the optical coupling component into the light-sensitive element would be maximized), and measuring respective propagation error amounts at each of these positions of separation. The results obtained are shown in FIG. 12.

From the results of measurement of propagation errors shown in FIG. 12, it can be seen that there is a tendency for propagation errors to be reduced as the separation between the front face of the light-sensitive element 66 and the end face of the optical fiber cable 62, which is the optical transmission medium, is set to more than the separation with which the coupling efficiency of energy into the light-sensitive element 66 from the optical fiber cable 62 is maximized.

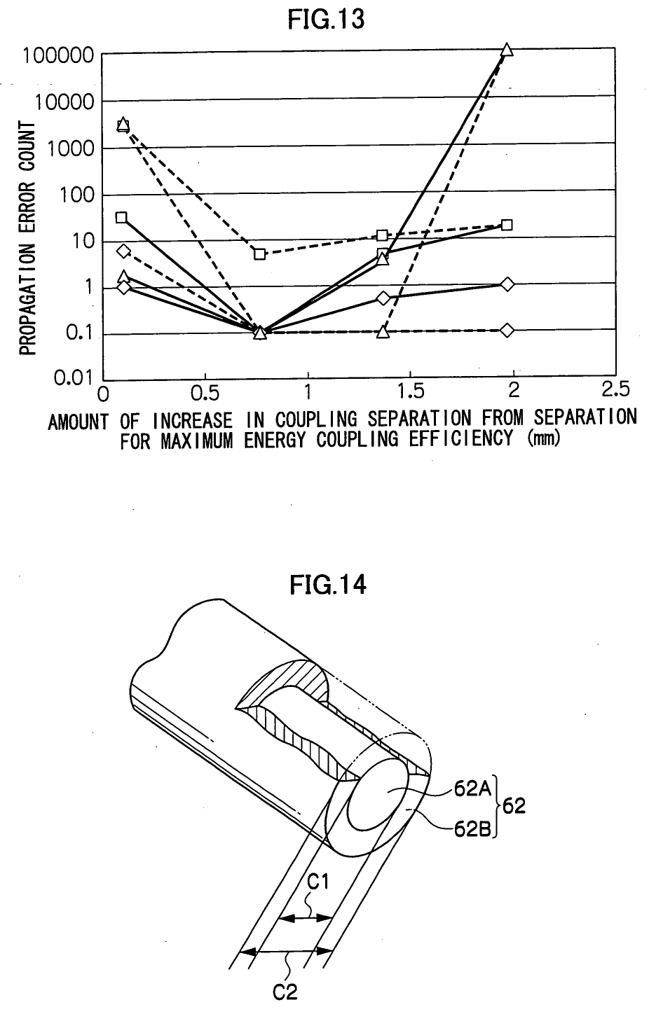

Subsequently, a light emission amount of the light emitting element 64 was set to be smaller than at the time of the experiment of FIG. 12 and, under similar conditions to those of FIG. 12, the end portion of the optical fiber cable 62 was separated in a number of separation steps from the separation at which the coupling efficiency of energy from the optical coupling component into the light-sensitive element would be maximized and respective propagation error amounts were measured at each of these positions. The results obtained are shown in FIG. 13.

From the results of measurement of propagation errors shown in FIG. 13, it can be seen that, as the separation between the front face of the light-sensitive element 66 and the end face of the optical fiber cable 62, which is the optical transmission medium, is gradually made larger than the separation with which the coupling efficiency of energy from the light-sensitive element 66 into the optical fiber cable 62 is maximized, at first propagation errors are reduced but there is a tendency for propagation errors to increase again when the separation is made even larger.

Accordingly, a test was carried out in order to establish a propagation error reduction setting range E for the receptacle 56 and the output plug 60, which are the optical coupling component, in practical conditions. This test was evaluated and the results obtained are shown in table 1 below.

TABLE 1
Test and Evaluation for Determining Propagation
Error Reduction Setting Range

| | Distance between optical element (package | | | | | | | |
|---|---|---|---|---|---|---|---|---|
| | face) and optical transmission medium | | | | | | | |
| | (end face) (mm) | | | | | | | |
| | 0.3 | 0.8 | 1 | 1.3 | 1.5 | 1.8 | 2.3 | 2.8 |
| Evaluation of | D | B | A | A | A | A | B | C |
| propagation error | | | | | | | | |
| suppression | | | | | | | | |
| Evaluation of | A | A | A | A | A | A | B | C |
| light energy | | | | | | | | |
| coupling efficiency | | | | | | | | |

Evaluation key
A: Good
B: Useable in practice
C: Potentially problematic in practice
D: Poor

For this test, GI-HPCF (HG20-06, manufactured by Sumitomo Electrics Industries, Ltd.) was used as the optical fiber cable 62. As shown in FIG. 14, this optical fiber cable 62 is structured with a core 62A (a light propagation region) of quartz glass, a diameter C1 of the core 62A is 200 μm, and a diameter C2 of cladding 62B is 230 μm.

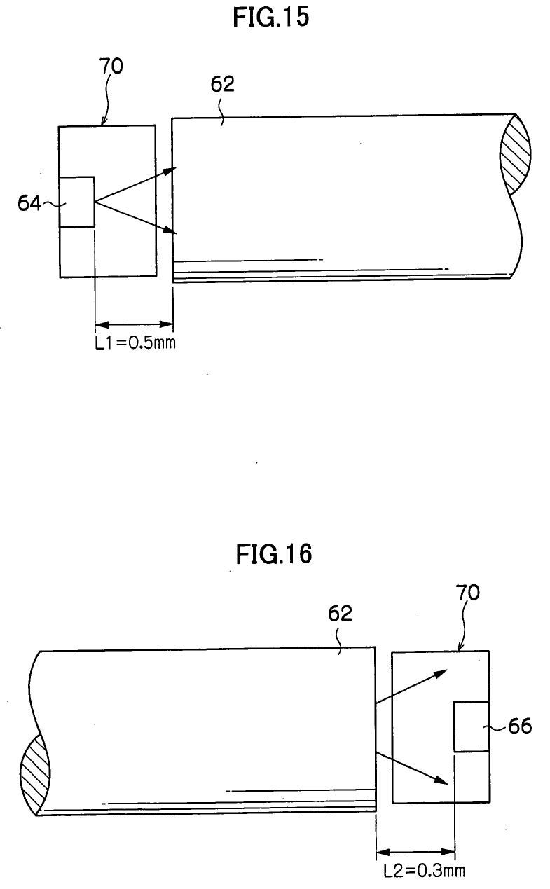

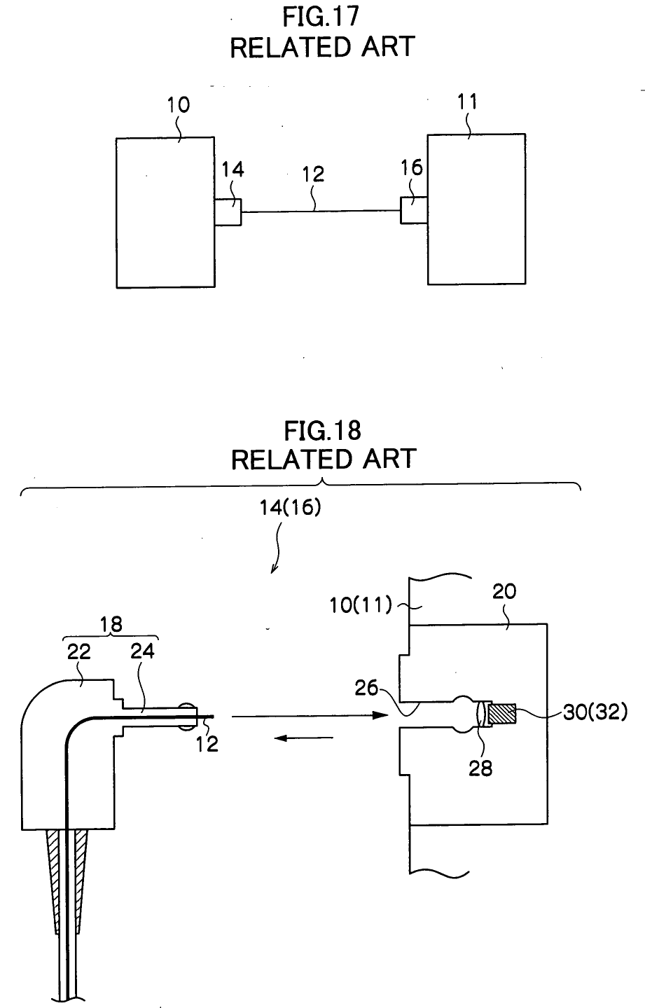

In this test, as shown in FIG. 15, at the butting-coupled receptacle 52 and input plug 58, a separation L1 with which coupling efficiency of energy between the light emitting element 64 in the optical element package 70 (here, a VCSEL laser chip was employed as the light emitting element 64) and the end face of the optical fiber cable 62 (i.e., an end face of the core 62A) was maximized was 0.5 mm.

In this case, the VCSEL, manufactured by Fuji Xerox Co., Ltd., which is a vertical cavity surface emitting laser having a higher emission efficiency than an edge emitting laser, was used with a view to balancing suppression of amounts of light irradiated outside the apparatus to within laser safety standards with an increase in detection sensitivity.

Further, from this test, as shown in FIG. 16, at the butting-coupled receptacle 56 and output plug 60, a separation L2 for maximizing coupling efficiency of energy between the light-sensitive element 66 of the optical element package 70 (here, a PD chip, which is a photodiode, was employed as the light-sensitive element 66) and an end face of the optical fiber cable 62 (i.e., an end face of the core 62A) was 0.3 mm.

A value of output of the light emitting element 64 employed in this test was 780 W. A total length of the optical fiber cable 62 that was used in the test was 30 m.

According to the above, if the effect of reduction of propagation errors and the condition of coupling efficiency of energy in light energy propagation are considered together, practicable results are obtained with a propagation error reduction setting range E in a range of at least 0.6 mm and at most 2.8 mm. A particularly desirable range of the propagation error reduction setting range E is from 1.0 mm to 1.8 mm.

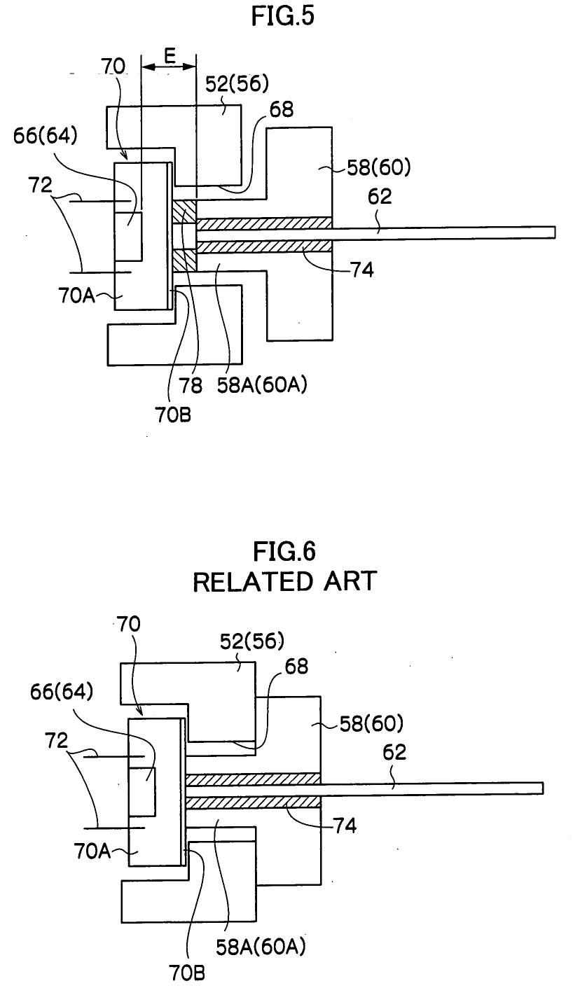

Next, structural examples will be described in accordance with FIGS. 4 and 5. In these structures, the receptacle 52 and input plug 58, with widely marketed structures which would usually be butting-coupled with a separation such that energy coupling efficiency is maximized, are employed in structures such that, when optical signals are propagated by multimode light beams, propagation errors are lessened while propagated light energy is appropriately maintained.

In the structure of FIG. 4, a spacer member 76, with a predetermined thickness for setting the propagation error reduction setting range E, is disposed between a housing end face for abutting of the receptacle 52 (or the receptacle 56) and a casing end face for abutting of the input plug 58 (or the output plug 60). (A member such as a spring member or the like that is capable of setting a predetermined spacing could also be used as the spacer.)

In the structure of FIG. 5, a washer-like spacer member 78, with a predetermined thickness for setting the propagation error reduction setting range E, is disposed between a surface of the optical element package 70 of the receptacle 52 (or the receptacle 56) around the window portion 70B and a surface of the insertion portion 58A (or the insertion portion 60A) of the input plug 58 (or the output plug 60) around the distal end face of the optical fiber cable 62.

Note that structures are also possible in which the spacer member 76 or the washer-like spacer member 78 is substituted with a member such as a spring member or the like that is capable of setting a predetermined spacing. Furthermore, for this optical linking system, structures are possible in which the propagation error reduction setting range E is set at one or both of the receptacle 52 of the transmitter 50 and the receptacle 56 of the receiver 54.

Second Embodiment

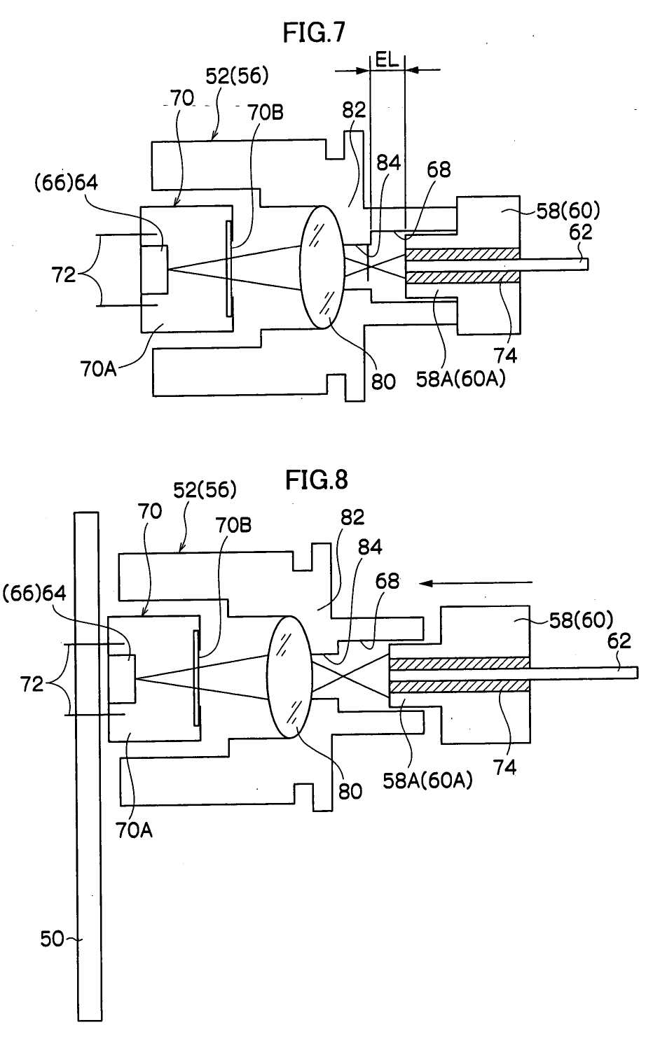

Next, a second embodiment relating to the present invention will be described with reference to FIGS. 7 to 12.

In the present embodiment, a structure which is provided with a collector lens 80 is employed as the transmitter 50 side receptacle 52 (and/or the receiver 54 side receptacle 56) for structuring the optical coupling component.

At the transmitter 50 side receptacle 52 (or the receiver 54 side receptacle 56) which employs this collector lens, as shown by the examples in FIGS. 7 and 8, a light guide aperture 84 is formed through a floor portion of the coupling insertion hole 68, which is formed in a housing 82 of the receptacle 52 (or 56). The collector lens 80 is disposed in the housing 82 at the optical element package 70 side relative to the light guide aperture 84.

At this housing 82, the optical element package 70 is disposed on a path of light which is focused by the collector lens 80. The optical element package 70 has a structure in which the light emitting element 64 (or the light-sensitive element 66) is disposed on an interior bottom face of a metal package, and the window portion 70B is provided for allowing a multimode light beam emitted from the light emitting element 64 to pass through the window portion 70B and be irradiated to the exterior (or for allowing a multimode light beam emitted from the optical fiber cable 62 to pass through the window portion 70B and be incident on the light-sensitive element 66). This optical element package 70 is structured to be connected with the circuit of the transmitter 50 by the electronic terminals 72 protruding from the bottom face of the package 70A.

In an optical coupling component employing the collector lens which is structured thus, in order to reduce propagation errors, the insertion portion 58A of the input plug 58 (or the insertion portion 60A of the output plug 60) is, for example, formed to be shortened by a predetermined length such that, in the state in which the input plug 58 is connected to the receptacle 52 (or the output plug 60 is connected to the receptacle 56), a distance from a focal position on the light path at the propagation medium side (i.e., the optical fiber cable 62 side) of the collector lens 80 to the end face of the optical fiber cable 62 falls in a range specified for reducing propagation errors EL.

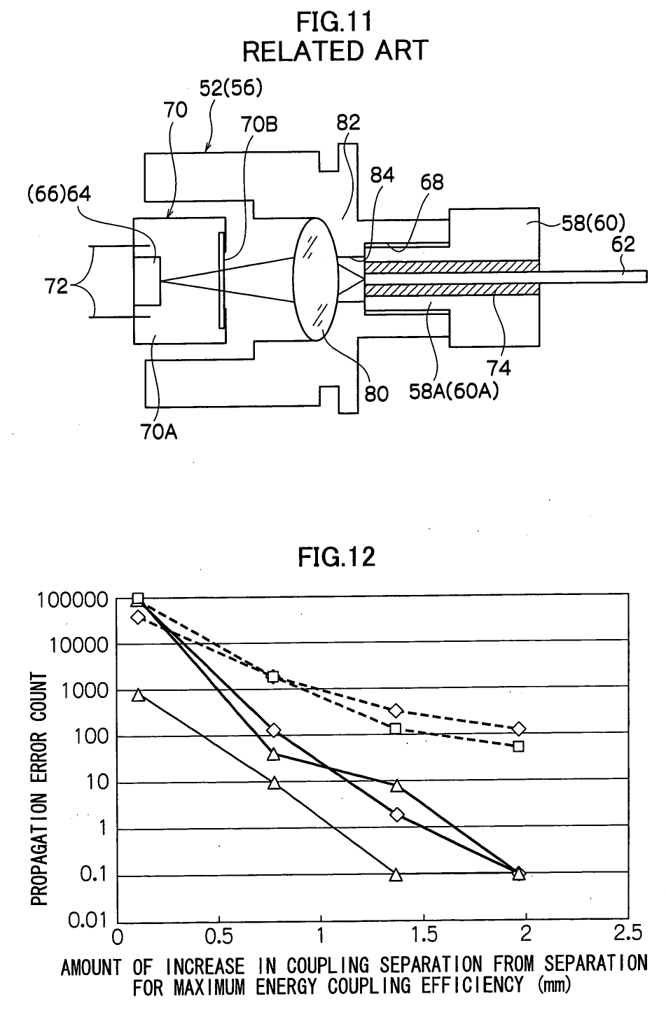

In a conventional state in which the input plug 58 (or the output plug 60) is coupled with the receptacle 52 (or the receptacle 56) using a collector lens, it is usual, as in the comparative example shown in FIG. 11, for the end face of the optical fiber cable 62 at the light emitting element 64 side coupling component to be set to be positioned at a location at which light emitted from the light emitting element 64 is most tightly focused and for the light-sensitive element 66 at the light-sensitive element 66 side coupling component to be set to be positioned at a location at which light emitted from the optical fiber cable 62 is most tightly focused. Thus, coupling efficiencies of energy between the light emitting element 64 (and the light-sensitive element 66) and the optical coupling components are maximized.

A relationship between the distance from the focal position at the propagation medium side (the optical fiber cable 62 side) of the collector lens 80 (i.e., the position at which light emitted from the light emitting element 64 is most tightly focused) to the end portion of the optical fiber cable 62 and an amount of propagation errors is found by experiment and evaluated, and the propagation error reduction setting range EL of this optical coupling component using a collector lens is set to a suitable range which is capable of reducing propagation errors.

The propagation error reduction setting range EL of this optical coupling component employing a collector lens, as found by such testing, may be set as the separation from the front face of the window portion 70B to the end face of the optical fiber cable 62, which has been described hereabove as the propagation error reduction setting range E of butting coupling as shown in table 1. The distance from the front face of the window portion 70B to the end face of the optical fiber cable 62 may be obtained by subtracting the distance from the front face (light emission face) of the light emitting element 64 (or the light-sensitive element 66), which is an optical device, to the front face of the window portion 70B (i.e., the light amount-maximizing distance) from the distance from the front face (light emission face) of the light emitting element 64 (or the light-sensitive element 66) to the end face of the optical fiber cable 62.

Thus, the propagation error reduction setting range EL of the optical coupling component that employs a collector lens is in a range of from 0.3 mm to 2.5 mm to the propagation medium side (the optical fiber cable 62 side) from the position at which light energy propagated by the optical coupling component is maximized (i.e., the propagation medium side focal position of the collector lens 80).

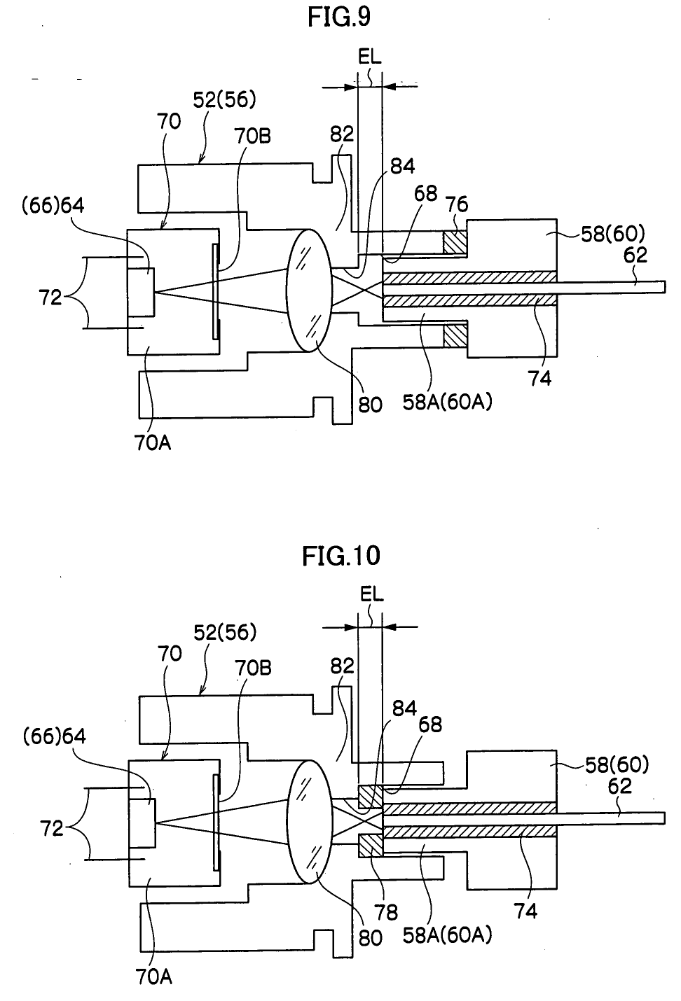

Next, structural examples will be described in accordance with FIGS. 9 and 10. In these structures, the receptacle 52 and input plug 58, with a widely marketed structure of the optical coupling component using a collector lens which would usually be structured so as to couple with a separation such that energy coupling efficiency is maximized, are employed in structures such that, when optical signals are propagated by multimode light beams, propagation errors are lessened while propagated light-energy is appropriately maintained.

In the structure of FIG. 9, the spacer member 76, with a predetermined thickness for setting the propagation error reduction setting range EL, is disposed between a housing end face for abutting of the receptacle 52 (or the receptacle 56) and a casing end face for abutting of the input plug 58 (or the output plug 60). (A member such as a spring member or the like that is capable of setting a predetermined spacing could also be used as the spacer.)

In the structure of FIG. 10, the washer-like spacer member 78, with a predetermined thickness for setting the propagation error reduction setting range EL, is disposed between a surface of the receptacle 52 (or the receptacle 56) around the light guide aperture 84 (i.e., a portion of the bottom face of the coupling insertion hole 68) and a surface of the insertion portion 58A of the input plug 58 (or the insertion portion 60A of the output plug 60) around the distal end face of the optical fiber cable 62.

Note that structures are also possible in which the spacer member 76 or the washer-like spacer member 78 is substituted with a member such as a spring member or the like that is capable of setting a predetermined spacing. Furthermore, for this optical linking system, structures are possible in which the propagation error reduction setting range EL is set at one or both of the receptacle 52 of the transmitter 50 and the receptacle 56 of the receiver 54.

Structures, operations and effects of this second embodiment other than those described above are similar to those of the earlier-described first embodiment. Accordingly, similar members have been assigned the same reference numerals and descriptions thereof have been omitted. Furthermore, the present invention is not limited to the first and second embodiments described above, and various other structures can be utilized within a scope that does not depart from the spirit and scope of the present invention.

What is claimed is:

1. A method that reduces communication errors in an optical communication system which includes an optical element and an optical transmission medium, the method comprising:
setting a relative position of the optical element and an end face of the optical transmission medium, at which light emitted from the optical element is incident, to a (relative) position which is different from a relative position of the optical element and the end face of the optical transmission medium with which propagated light energy is maximized; and
propagating, in multimode, light emitted from the optical element through the optical transmission medium.

2. A butt-optical-coupling structure comprising:
an optical element; and
an optical transmission medium which propagates, in multimode, light emitted from the optical element,
wherein a relative position of the optical element and an end face of the optical transmission medium is set to a (relative) position which differs, by a predetermined distance in a direction of an optical axis of the optical transmission medium, from a relative position of the optical element and the end face of the optical transmission medium with which propagated light energy is maximized.

3. The butt-optical-coupling structure of claim 2, wherein the optical element is at least 0.6 mm and at most 2.8 mm away from the end face of the optical transmission medium.

4. An optical coupling structure comprising:
an optical element;
at least one collector lens; and
an optical transmission medium which transmits and receives light emitted from the optical element via the collector lens and propagates the light in multimode,
wherein a relative position of the optical element and an end face of the optical transmission medium is set to a (relative) position which differs, by a predetermined distance in a direction of an optical axis of the optical transmission medium, from a relative position of the optical element and the end face of the optical transmission medium with which propagated light energy is maximized.

5. The optical coupling structure of claim 4, wherein,
at the relative position with which propagated light energy is maximized, a position of the end face of the optical transmission medium is at a focal position of the collector lens, and
the optical element and the end face of the optical transmission medium are set to a position which differs, by the predetermined distance in the direction of the optical axis of the optical transmission medium, from the focal position.

6. The optical coupling structure of claim 5, wherein
the focal position is between the optical element and the end face of the optical transmission medium, and
the focal position is at least 0.3 mm and at most 2.5 mm away from the end face of the optical transmission medium.

7. An optical communication system comprising:
a first signal communication apparatus;
a second signal communication apparatus; and
an optical signal propagation medium which propagates light between the first signal communication apparatus and the second signal communication apparatus in multimode, wherein
the first signal communication apparatus includes a first optical element,
the second signal communication apparatus includes a second optical element,
the first signal communication apparatus converts at least some of electronic signals inputted from outside the optical communication system to optical signals with the first optical element, and transmits the optical signals into the optical signal propagation medium,
the second signal communication apparatus receives the optical signals from the optical signal propagation medium, converts at least some of the optical signals to electronic signals with the second optical element, and outputs the electronic signals to outside the optical communication system,
and a relative position of the first optical element and a first optical element side end face of the optical signal propagation medium is set to a (relative) position which differs, by a predetermined distance in a direction of an optical axis of the optical signal propagation medium, from a relative position of the first optical element and the end face of the optical signal propagation medium with which propagated light energy is maximized.

8. The optical communication system of claim 7, wherein the first optical element is at least 0.6 mm and at most 2.8 mm away from the first optical element side end face of the optical signal propagation medium.

9. The optical communication system of claim 7, further comprising at least one collector lens, which is disposed between the first optical element and the first optical element side end face of the optical signal propagation medium for focusing light emitted from the first optical element.

10. The optical communication system of claim 9, wherein,
at the relative position with which propagated light energy is maximized, a position of the end face of the optical signal propagation medium is at a focal position of the collector lens, and
the first optical element and the first optical element side end face of the optical signal propagation medium are set to a position which differs, by the predetermined distance in the direction of the optical axis of the optical signal propagation medium, from the focal position.

11. The optical communication system of claim 10, wherein
the focal position is between the first optical element and the first optical element side end face of the optical signal propagation medium, and
the focal position is at least 0.3 mm and at most 2.5 mm away from the optical signal propagation medium.
